(19) United States
(12) Patent Application Publication
(10) Pub. No.: US 2019/0014239 A1
(43) Pub. Date: Jan. 10, 2019

(54) SCENE ANALYZING METHOD AND MONITORING DEVICE USING THE SAME

(71) Applicant: Nanjing Yuanjue Information and Technology Company, Nanjing (CN)

(72) Inventors: LIMING ZHENG, Nanjing (CN); Tao Yu, Nanjing (CN); Bingbing Cui, Nanjing (CN)

(73) Assignee: Nanjing Yuanjue Information and Technology Company, Nanjing (CN)

(21) Appl. No.: 15/800,104

(22) Filed: Nov. 1, 2017

(30) Foreign Application Priority Data
Jul. 10, 2017 (CN) 201710556060.5

(51) Int. Cl. H04N 5/14; G06T 7/00; G06F 17/30

(52) U.S. Cl. CPC H04N 5/147; G06T 7/00; G06T 2207/10028; G06F 17/3025; G06F 17/30262

(57) ABSTRACT

A scene analyzing method includes the steps of: receiving captured scene information; analyzing different targets in the scene information to obtain characteristic information of each of the targets; and sending the obtained characteristic information to an external device or correlating the characteristic information to the scene information and storing it to a storage device in order to retrieve the scene information corresponding to the characteristic information stored in the storage device. The scene information corresponding to the characteristic information is searchable to extract a specific target when the scene analyzing method is used for monitoring applications. This reduces human costs and increases efficiency in monitoring information.

### BACKGROUND OF THE INVENTION

### 1. Field of the Invention

The invention relates to an image processing technology and, in particular, to a scene analyzing method and a monitoring device using the same.

### 2. Description of Related Art

Most of the monitoring devices in the prior art use a camera to capture image information and store the image information. When the monitoring information is required, the images are analyzed by human to recognize targets in the images. This process involves a lot of manpower and material supports. Besides, screening by human is likely to make mistakes. Therefore, the monitoring information cannot be fully utilized.

### SUMMARY OF THE INVENTION

In view of the foregoing, the invention provides a scene analyzing method and a monitoring device using the same. The scene analyzing method includes the steps of:

a. receiving captured scene information containing targets;

b. analyzing different targets in the scene information to obtain characteristic information of each of the targets; and

c. sending the characteristic information to an external device, or correlating the characteristic information to the scene information and storing the characteristic information to a storage device in order to retrieve the scene information based on the characteristic information stored in the storage device.

Another objective of the invention is to provide a monitoring system utilizing the above-mentioned scene analyzing method, the system comprising:

an image analyzing device for receiving scene information containing targets, analyzing different targets in the scene information to obtain analysis results comprising characteristic information of each of the targets, and correlating the characteristic information with the scene information;

a storage device connected to the image analyzing device for storing the analysis results; and

a server connected to the image analyzing device and the storage device for obtaining the analysis results and retrieving data stored in the storage device.

According to the above-mentioned technique, the invention makes use of clustering recognition to extract targets in the scene information and the characteristic information of the targets. Using image depth recognition techniques and spiral curve orientation, the location and motion information of targets can be included in the characteristic information. The characteristic information is then correlated to the scene information so that it becomes possible to extract specific scene information by searching associated characteristic information. This achieves the goal of automatic extraction of scene information captured through monitoring, saving manpower costs and increasing efficiency in monitoring information usage.

### BRIEF DESCRIPTION OF THE DRAWINGS

FIG. 1 is a block diagram of the monitoring system of the present invention;

FIG. 2 is a spiral curve applied in the invention;

FIG. 3 is a schematic view of using the spiral curve to determine the location of a target;

FIG. 4 is a schematic view of using the spiral curve to determine the change in the location of a target;

FIG. 5 is a schematic view of using multiple image capturing devices for monitoring; and

FIG. 6 is a flowchart of the monitoring method of the present invention.

### DETAILED DESCRIPTION OF THE PREFERRED EMBODIMENT

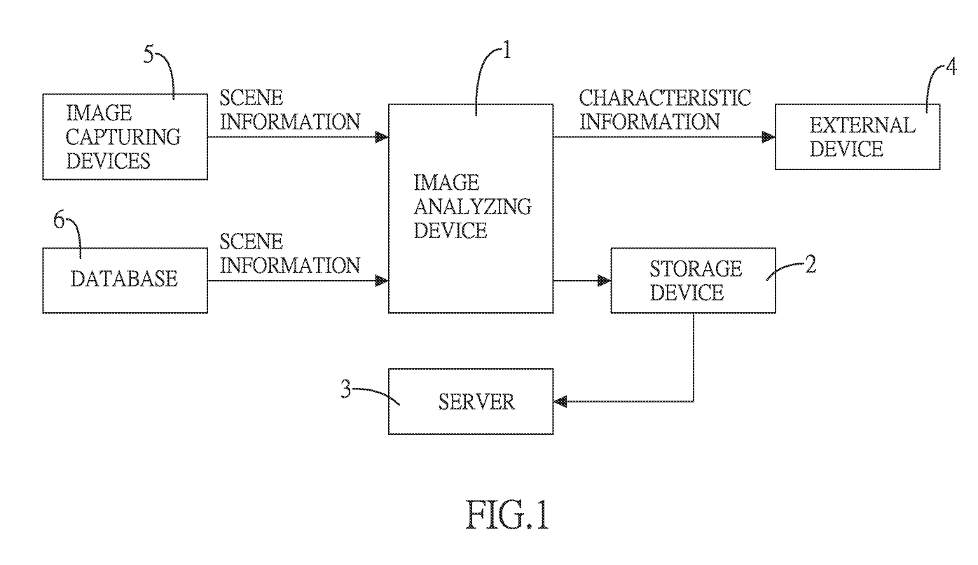

The invention provides a monitoring system that, as shown in FIG. 1,comprises an image analyzing device 1, a storage device 2, and a server 3.

The image analyzing device 1 receives scene information that contains targets. The image analyzing device 1 analyzes different targets in the scene information to obtain analysis results that comprise characteristic information of each of the targets. The image analyzing device 1 may be a cloud server. The storage device 2 is connected with the image analyzing device 1 for storing the analysis results of the image analyzing device 1, such as the characteristic information of the targets. In an embodiment, the characteristic information may comprise appearance information, including but not limited to the profile shape, texture and color of each target. The server 3 obtains analysis results from the image analyzing device 1, and is connected with the server 3 and the storage device 2 for retrieving data stored in the storage device 2.

In an embodiment of the invention, the scene information received by the image analyzing device 1 is collected by an image capturing device 5. Preferably, the image analyzing device 1 can be a vision processing chip integrated in the image capturing device 5. More specifically, the image analyzing device 1 can be a FPGA vision processing chip.

In another embodiment of the invention, the scene information received by the image analyzing device 1 may be e the scene information pre-stored in a database 6.

The image analyzing device 1 receives the scene information and analyzes and recognizes the scene information for recognizing targets in the scene information and obtaining characteristic information of each target. Preferably, the image analyzing device 1 can use the method for monocular vision space recognition in quasi-earth gravitational field environment to analyze targets in the scene information. More explicitly, the method for monocular vision space recognition in quasi-earth gravitational field environment includes the following steps:

(1) Perform a super pixel image partition for the scene information based upon pixel colors and spatial positions.

(2) Utilize a super pixel feature-based spectral clustering algorithm to reduce the dimension of the super pixels to a large block clustering image. Preferably, the features used in the spectral clustering algorithm include, but not limited to, super pixel color space distance, texture feature vector distance, and geometrical adjacency.

(3) Classify the large block clustering image. More explicitly, according to models of sky, ground and objects along with the image perspective, a fuzzy distribution density function of the gravity field is constructed. The density function is used to compute an expectation value for each large block pixel, thereby classifying the large block pixels and forming a classification diagram.

(4) For the classification diagram done with the preliminary classification, perform characteristic classification algorithms such as wavelet sampling and Manhattan direction extraction to extract an accurate classification diagram of the sky, ground and objects, thereby identifying different targets in the scene information.

(5) Extract characteristics of the recognized targets, such as the profile shape, texture, and color thereof, and generate the characteristic information accordingly.

More preferably, after the image analyzing device 1 completes clustering recognition for the scene information, it further performs depth recognition for the scene information and the targets therein based on an aperture imaging model and ground linear perspective information. This converts the planar scene information captured by the image capturing device 1 to three-dimensional scene information. The area occupied by each of the targets in the field of view of the image capturing device 1 is used to estimate the relative position between the target and the image capturing device 5. Preferably, in addition to the area occupied by the target in the field of view, the criteria for estimate the relative position between the target and the image capturing device 5 also include, but not limited to, one or a combination of such features as the number of super pixels occupied by the target in the scene information, a profile size of the target, a distance from the target to the center of the scene information, and a distance from the target to the edge of the scene information. The relative position between each of the targets and the image capturing place 1 is also added to the characteristic information.

When the image analyzing device 1 receives two or more sets of scene information or continuous scene information, the image analyzing device 1 analyzes whether different sets of scene information contain same targets. When there are same targets, the relative position of each of the targets is used to analyze the motion of the target. For the same target, if the position thereof in earlier scene information is farther away (e.g., the number of super pixels occupied by the same target in earlier scene information is fewer) and the position thereof in later scene information is closer (e.g., the number of super pixels occupied by the same target in later scene information is more), then the target is determined to be moving toward the scene information capturing place such as the image capturing device 5. On the other hand, if the position thereof in earlier scene information is closer (e.g., the number of super pixels occupied by the same target in earlier scene information is more) and the position thereof in later scene information is farther away (e.g., the number of super pixels occupied by the same target in later scene information is fewer), then the target is determined to be moving away from the scene information capturing place. Combining the above-mentioned relative motion and position information, the invention can estimate an actual three-dimensional moving direction of the target in the scene information. The moving direction information of the target is also added to the characteristic information.

If a target suddenly disappears from the scene information captured at a later time in the sets of scene information, then the disappearing position of the target is used to determine whether the disappearing is normal. If the disappearing position is at an edge of the field of view in the scene information, then the disappearing of the target is normal. If the disappearing position is not at an edge, then the disappearing of the target is abnormal. In the case of an abnormal disappearing, the characteristic information of the target is preserved. From then on, the invention looks for the target in even later scene information until the target is discovered again. In this case, the above-mentioned comparison analysis is performed to complete the characteristic information of the target. Preferably, in order to save the device cost in actual operations, the stored characteristic information of the target is kept only for a specific time. Once the time passes beyond the specific time, the target is not searched any more.

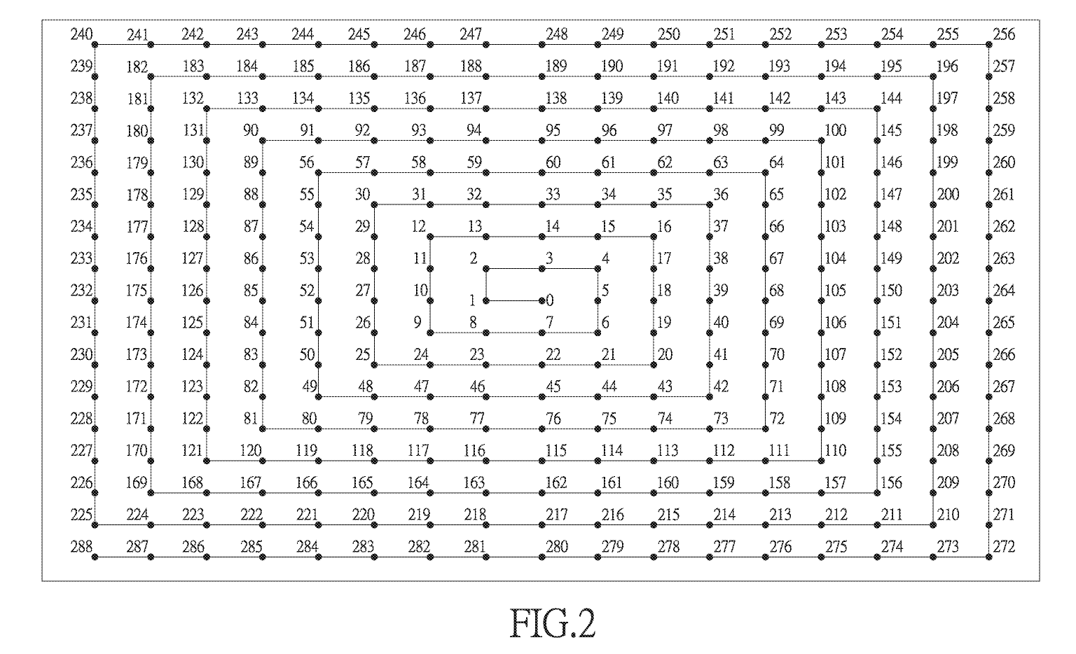

Preferably, when the image analyzing device 1 analyzes the scene information, as shown in FIG. 2, the scene information has a field of view. The field of view may be provided with a plurality of sampling points or grids along a spiral curve starting from the center the field of view.

Furthermore, the sampled points or grids are given descending numerals from the starting point of the spiral curve to the end. Preferably, the sampled points or grids are distributed at equal distance along the spiral curve. In another embodiment, the sampled points or grids are given ascending numerals from the starting point of the spiral curve to the end. More specifically, the number of the sampling points or grids is the square of an odd number. In this embodiment, the odd number is 17 and there are 289 sampling points. More preferably, the end of the spiral curve is close to an edge of the field of view. As shown in FIG. 2, the spiral curve ends at a corner of the field of view. The sampling points and grids present a specific pattern. As shown in the drawing, the spiral curve winds clockwise. In this case, the sampling points or grids along a diagonal line from the center to the upper right corner of each winding are labeled as (2n)², where n is the winding number of the spiral curve and the center has n=0. The sampling points or grids along a diagonal line from the center to the lower left corner of each winding are then labeled as (2n−1)². The sampling points or grids along a diagonal line from the center to the upper left corner of each winding are labeled as (2n)²−2n. The sampling points or grids along a diagonal line from the center to the lower right corner of each winding are labeled as (2n−1)²−(2n−1). According to the above-mentioned rule, the position of each sampling point or grid can be quickly identified according to the numeral thereof.

In short, the sampling points are distributed at equal distance along the spiral curve according to the aspect ratio of the field of view, the number of the sampling points is the square of an odd number, the sampling points are given ascending numerals starting from 0 and ending at the square of the odd number minus 1, so that the sampling points whose numerals are squares of odd numbers, such as sampling points having numerals 1, 9, 25, 49 and so forth, and the sampling points whose numerals are squares of even numbers such as the sampling points having numerals 4, 16, 36, 64 and so forth, are respectively on the lower-left side and upper-right side of the upper-right to lower-left diagonal of the field of view.

After using the spiral curve to label the sampling points or grids in the field of view, the sampling points or grids can be used as a base to perform super pixel partitions and clustering recognition to targets in the scene information, to sense the depths of the targets, to estimate the relative position of the targets, to confirm the target positions, to determine how the targets and the image capturing device are moving relative to one another. Through the numbered sampling points or grids and their relations with respect to the above-mentioned corners, it is possible to quickly specify super pixels, clustering recognition large blocks, and target positions. At the same time, the sampling points can be used as measures to determine the position of a target and the distance between the target and the image capturing device. Moreover, combining the number of sampling points or grids covered by the target and the depth sensing in the scene information, the invention can quickly determine the area occupied by the target, the number of super pixels covered by the target, the profile size thereof, the distance of the target to the center or the edges of the scene information, thereby quickly estimating the relative positions.

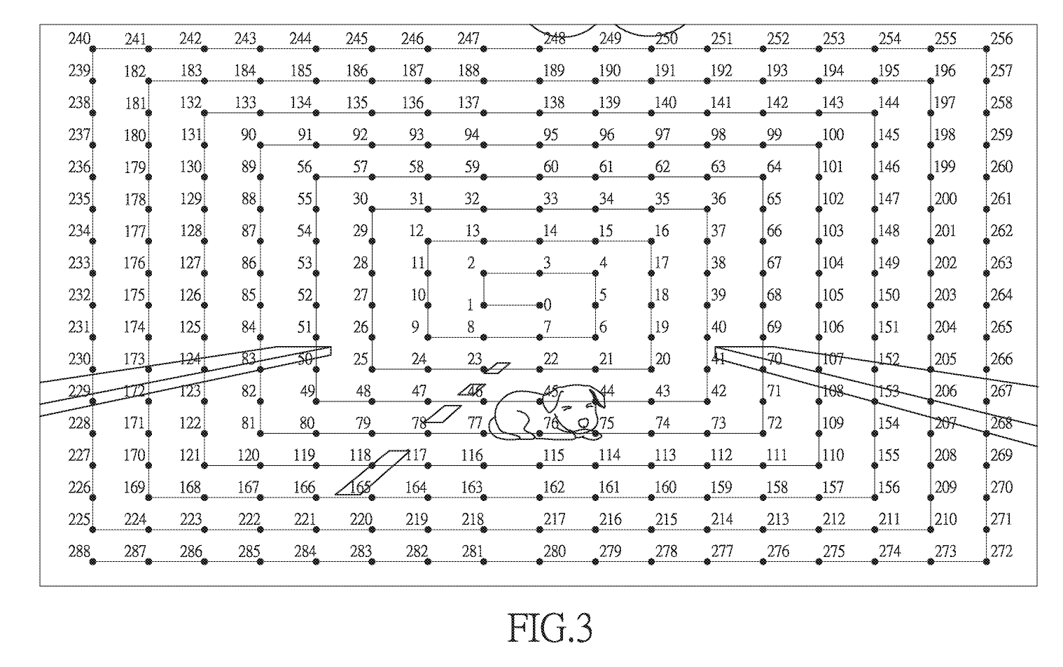

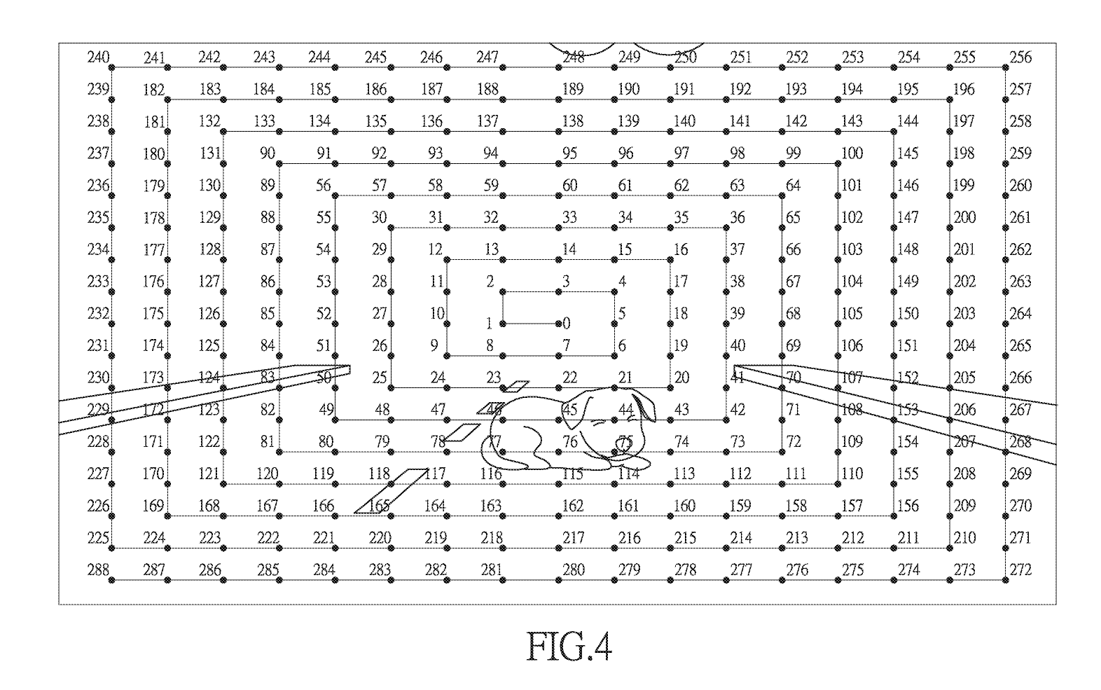

For example, the target in FIG. 3 is a dog. The sampling points covered by the dog has the numerals 44, 45, 75 and 76. As the target changes its position, as shown in FIG. 4, the numerals of the sampling points covered by the target become 44, 45, 46, 75, 76 and 77. Thus, the change in the target position can be determined from the numerals of the associated sampling points. If the image capturing device 5 is installed at a fixed location, the background in the scene information is essentially unchanged. Therefore, the position and moving direction of the target can be readily determined by reference to the sampling points on the spiral curve.

When perform the clustering analysis of the target, the scene analysis method of the present invention may use an image processing method disclosed in the Chinese Patent application number 201510068199.6, the sampling points or grids can be used as seeds for clustering operations, so that the clustering analysis can be faster and more accurate.

After the image analyzing device 1 analyzes and obtains targets and the characteristic information thereof, the characteristic information and the associated target, the scene information containing the target, and captured time of the scene information are correlated in such a way that one can search one piece of information using any of the other information. For example, by specifying some particular characteristic information, the invention can search and obtain the target having the characteristic information, the scene information of the target, and the captured time of the scene information.

Preferably, the image analyzing device 1 can perform a second analysis on the characteristic information in order to associate it with some text, voice, or a specific action or operation. In this case, one can use text searches, voice searches, action instructions, or operations to search for the characteristic information. This enables users to search using text, voices, actions, or operations.

As shown in FIG. 1, an external device 4 can connect to the image analyzing device 1. One can operate the external device 4 to retrieve the analysis results of the image analyzing device 1, thereby searching for a target using the characteristic information, the corresponding scene information or the captured time of the scene information. Preferably, the user can enter text, voices, actions, or operations via the external device 4 to retrieve the characteristic information and targets analyzed and obtained by the image analyzing device 1, thereby obtaining statistical analysis results for the corresponding characteristic information or targets. One can also use the characteristic information or targets to retrieve the corresponding scene information or the captured time thereof.

The image analyzing device 1 can match the obtained target and the characteristic information thereof to some scene information and store the matching information to the storage device 2. Therefore, one can retrieve scene information stored in the storage device 2 via the server 3. The user can operate the server 3 to retrieve analysis results of the image analyzing device 1. This then achieves the goal of searching for a target using characteristic information, searching for a target and the corresponding scene information or captured time thereof using characteristic information, and so on. Preferably, one can enter text, spoken sounds, specific actions or operations via the server 3 to retrieve the characteristic information and targets obtained by the image analyzing device 1, thereby obtaining statistical analysis results for the corresponding characteristic information or targets. One can also use the characteristic information or target to retrieve the corresponding scene information or a captured time of the scene information. Preferably, the server 3 is connected to the storage device 2 via cloud.

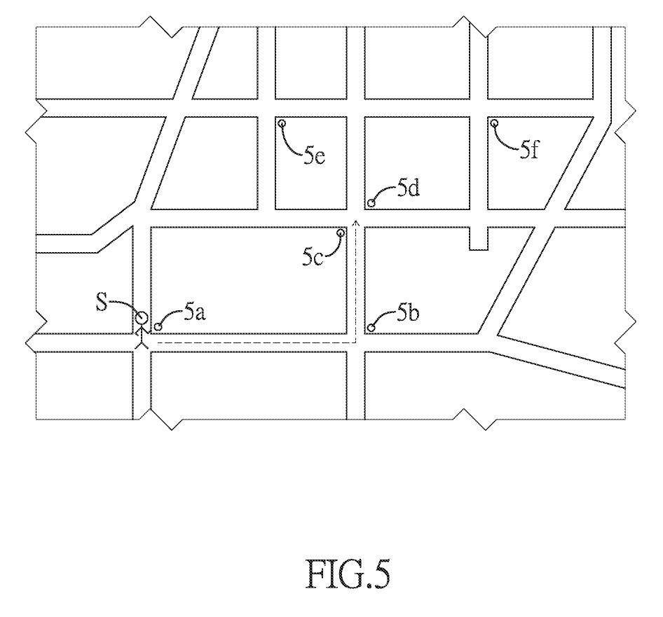

As shown in FIG. 1, the server 3 can further connect to the image capturing device 5 to control the image capturing device 5 to collect scene information in a specific direction. Through the orientation of multiple image capturing devices 5, the invention can achieve the goal of monitoring some specific region. For example, as shown in FIG. 5, two or more image capturing devices 5a-5f are installed for an area. The invention can accurately monitor the motion of the target S. Suppose a crime happens. The invention can monitor the location and path of the target S, thereby knowing the area that the target S is going to. If several areas are installed with such monitoring systems, they can help tracking a target for the ease of the police to capture the target.

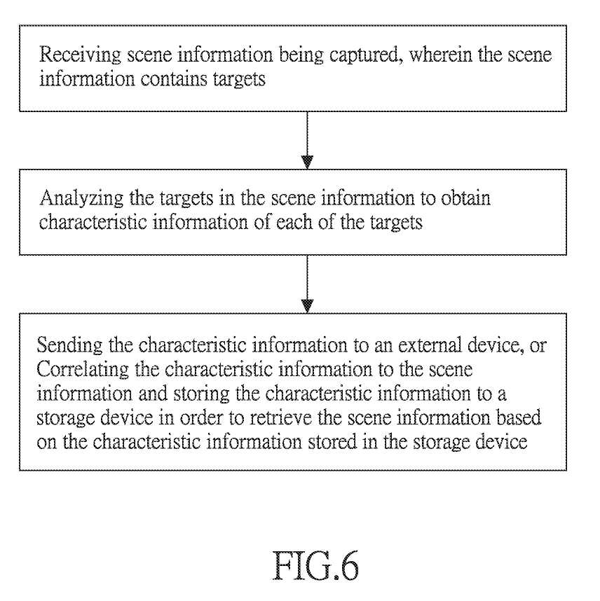

A scene analyzing method proposed by the invention has the steps shown in FIG. 6, including:

a. receiving captured scene information that contains targets;

b. analyzing different targets in the scene information to obtain analysis results comprising characteristic information of each of the targets;

c. transmitting the characteristic information to an external device, or correlating the characteristic information with the corresponding scene information and storing it to a storage device, and retrieving the scene information corresponding to the characteristic information according to the characteristic information stored in the storage device.

Moreover, in step a, the scene information may be captured by an image capturing device in real time or stored in a database.

Moreover, in step b, a method for monocular vision space recognition in quasi-earth gravitational field environment can be applied to analyze targets in the scene information. More explicitly, the method includes the following steps:

(1) Perform a super pixel image partition for the scene information based upon pixel colors and spatial positions.

(2) Utilize a super pixel feature-based spectral clustering algorithm to reduce the dimension of the super pixels to a large block clustering image. Preferably, the features used in the spectral clustering algorithm include, but not limited to, super pixel color space distance, texture feature vector distance, and geometrical adjacency.

(3) Classify the large block clustering image. More explicitly, according to models of sky, ground and objects along with the image perspective, a fuzzy distribution density function of the gravity field is constructed. The density function is used to compute an expectation value for each large block pixel, thereby classifying the large block pixels and forming a classification diagram.

(4) For the classification diagram done with the preliminary classification, perform characteristic classification algorithms such as wavelet sampling and Manhattan direction extraction to extract an accurate classification diagram of the sky, ground and objects, thereby identifying different targets in the scene information.

(5) Extract characteristics of the recognized targets, such as the profile shape, texture, and color thereof, and generate the characteristic information accordingly.

The invention also provides another scene analyzing method comprising the steps of:

a. obtaining scene information at different times;

b. analyzing different targets in the scene information at different times to obtain characteristic information of the targets, and further performing a step of:
b1) analyzing spatial location information of each of the targets;

c. transmitting obtained characteristic information, including the location information, to the server, or correlating the characteristic information and the location information to the scene information and storing such information to the storage device, and retrieving one or multiple sets of the scene information according to the spatial location information stored in the storage device.

In step b1, each set of scene information and the targets therein are performed with depth sensing according to aperture image modeling and ground linear perspective information, thereby converting the planar scene information captured by the monocular image capturing device to three-dimensional scene information. Therefore, it becomes possible to use the area occupied by each of the targets in the field of view to estimate the position of the target relative to the image capturing device. Preferably, in addition to the area occupied by the target in the field of view, the criteria also include, but not limited to, one or a combination of such features as the number of super pixels occupied by the target in the scene information, the profile size of the target, the distance from the target to the center of the scene information, and the distance from the target to the edges of the scene information.

In step b1, when two or more sets of scene information or continuous scene information is received, the scene information is analyzed to determine whether the scene information contains same targets. If there is a same target, the change in the position of the target is used to determine the motion of the target. For the same target, if the position thereof in earlier scene information is farther away (e.g., the number of super pixels occupied by the target in earlier scene information is fewer) and the position thereof in later scene information is closer (e.g., the number of super pixels occupied by the target in later scene information is more), then the target is determined to be moving toward the scene information capturing place. On the other hand, if the position thereof in earlier scene information is closer (e.g., the number of super pixels occupied by the target in earlier scene information is more) and the position thereof in later scene information is farther away (e.g., the number of super pixels occupied by the target in later scene information is fewer), then the target is determined to be moving away from the scene information capturing place. Combining the above-mentioned relative motion and position information, the invention can estimate the actual three-dimensional moving direction of the target in the scene information.

Preferably, the capturing of the scene information is based on a specific field of view. The field of view is provided with a plurality of sampling points or grids along a spiral curve starting at the center thereof.

Furthermore, the sampled points or grids are given ascending numerals from the starting point of the spiral curve to the end. Preferably, the sampled points or grids are distributed at equal distance along the spiral curve. More specifically, the number of the sampling points or grids is the square of an odd number. More preferably, the end of the spiral curve is close to an edge of the field of view. As shown in FIG. 2, the spiral curve ends at a corner of the field of view. The sampling points and grids present a specific pattern. As shown in the drawing, the spiral curve winds clockwise. In this case, the sampling points or grids along the diagonal line from the center to the upper right corner are labeled as (2n)², where n is the winding number and the center has n=0. The sampling points or grids along the diagonal line from the center to the lower left corner are then labeled as (2n−1)². The sampling points or grids along the diagonal line from the center to the upper left corner are labeled as (2n)²−2n. The sampling points or grids along the diagonal line from the center to the lower right corner are labeled as (2n−1)²−(2n−1). According to the above-mentioned rule, the position of each sampling point or grid can be quickly identified according to the numeral thereof.

After using the spiral curve to label the sampling points or grids in the field of view, the sampling points or grids can be used as a base to perform super pixel partitions and clustering recognition to targets in the scene information, to sense the depths of the targets, to estimate the relative position of the targets, to confirm the target positions, to determine how the targets and the image capturing device are moving relative to one another. Through the numbered sampling points or grids and their relations with respect to the above-mentioned corners, it is possible to quickly specify super pixels, clustering recognition large blocks, and target positions. At the same time, the sampling points can be used as measures to determine the position of a target and the distance between the target and the image capturing device. Moreover, combining the number of sampling points or grids covered by the target and the depth sensing in the scene information, the invention can quickly determine the area occupied by the target, the number of super pixels covered by the target, the profile size thereof, the distance of the target to the center or the edges of the scene information, thereby quickly estimating the relative positions.

When perform the clustering analysis of the target, the scene analysis method of the present invention may use an image processing method disclosed in the Chinese Patent application number 201510068199.6, the sampling points or grids can be used as seeds for clustering operations, so that the clustering analysis can be faster and more accurate.

According to the above-mentioned technique, the invention makes use of clustering recognition to extract targets in the scene information and the characteristic information thereof. Using image depth recognition techniques and spiral curve orientation, the location and motion information of targets can be added to the characteristic information. The characteristic information is then correlated to the scene information so that it becomes possible to extract specific scene information by searching associated characteristic information. This achieves the goal of automatic extraction of scene information captured through monitoring, saving manpower costs and increasing efficiency in monitoring information usage.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A scene analyzing method, comprising the steps of:
a. receiving scene information being captured, wherein the scene information contains targets;
b. analyzing the targets in the scene information to obtain characteristic information of each of the targets; and
c. sending the characteristic information to an external device, or correlating the characteristic information to the scene information and storing the characteristic information to a storage device in order to retrieve the scene information based on the characteristic information stored in the storage device.

2. The scene analyzing method of claim 1, wherein in step a, the scene information is captured in real time by an image capturing device.

3. The scene analyzing method of claim 1, wherein in step a, the scene information is pre-stored in a database.

4. The scene analyzing method of claim 1, wherein the characteristic information includes profile, texture or color of each target.

5. The scene analyzing method of claim 1, wherein:
in step a, the scene information is obtained at different times;
in step b, the different targets in the scene information at different times are analyzed to obtain the characteristic information of each of the targets, and the step b further includes a step of:
b1. analyzing position information of each of the targets; and
in step c, the characteristic information including the position information is sent to the external device, or correlating the characteristic information and the position information to the scene information and storing the characteristic information and the position information to the storage device in order to retrieve any one or more pieces of the scene information based on the position information stored in the storage device.

6. The scene analyzing method of claim 5, wherein in step a, the scene information is captured in real by an image capturing device.

7. The scene analyzing method of claim 6, wherein the image capturing device is installed at a fixed location.

8. The scene analyzing method of claim 6, wherein the image capturing device has a field of view, and multiple sampling points or grids within the field of view are sampled along a spiral curve extending from a center of the field of view.

9. The scene analyzing method of claim 8, wherein the sampling points are distributed at equal distance along the spiral curve according to the aspect ratio of the field of view, the number of the sampling points is the square of an odd number, the sampling points are given ascending numerals starting from 0 and ending at the square of the odd number minus 1, so that the sampling points whose numerals are squares of odd numbers and the sampling points whose numerals are squares of even numbers are respectively on the lower-left side and upper-right side of the upper-right to lower-left diagonal of the field of view.

10. The scene analyzing method of claim 8, wherein in step b1, the sampling points are used as a base to analyze spatial position information of the target in the scene information to determine a moving direction of the target in the field of view.

11. The scene analyzing method of claim 8, wherein in step b1, the characteristic information of a target is temporarily kept when the target disappears near the center of the field of view.

12. A monitoring system utilizing the scene analyzing method of claim 1, the system comprising:
an image analyzing device for receiving scene information containing targets, the image analyzing device analyzing different targets in the scene information to obtain analysis results comprising characteristic information of each of the targets and correlating the characteristic information with the scene information;
a storage device connected to the image analyzing device for storing analysis results; and
a server connected to the image analyzing device and the storage device for obtaining the analysis results and retrieving data stored in the storage device.

13. The monitoring device of claim 11, further comprising an image capturing device connected to the image analyzing device for capturing the scene information.

14. The monitoring device of claim 12, wherein the image analyzing device is an analyzing chip provided in image capturing device.

15. The monitoring device of claim 11, further comprising a database connected to the image analyzing device for storing the scene information.

16. The monitoring device of claim 12, wherein the image analyzing device is a cloud server that analyzes the scene information.

17. The monitoring device of claim 14, wherein the image analyzing device is a cloud server that analyzes the scene information.

18. The monitoring device of claim 16, the server further connects to the image capturing device to control the image capturing device in capturing the scene information and to control the image analyzing device to analyze the scene information captured by the image capturing device.

19. The monitoring device of claim 17, the server further connects to the image capturing device to control the image capturing device in capturing the scene information and to control the image analyzing device to analyze the scene information captured by the image capturing device.

20. The monitoring device of claim 11, wherein the image analyzing device correlates the characteristic information with one or any combination of a text, a language, an action and an operation in order to retrieve the characteristic information using one or any combination of the text, the language, the action and the operation.
